(19) United States
(12) Patent Application Publication
(10) Pub. No.: US 2017/0236123 A1
(43) Pub. Date: Aug. 17, 2017

(54) DECENTRALIZED PROCESSING OF GLOBAL NAMING SYSTEMS

(71) Applicant: BLOCKSTACK INC., New York, NY (US)

(72) Inventors: Muneeb ALI, Brooklyn, NY (US); Ryan SHEA, New York, NY (US); Jude NELSON, New Brunswick, NJ (US)

(21) Appl. No.: 15/433,957

(22) Filed: Feb. 15, 2017

Related U.S. Application Data
(60) Provisional application No. 62/296,002, filed on Feb. 16, 2016.

(51) Int. Cl. G06Q 20/40; H04L 9/32; G06F 17/30; G06F 21/60; H04L 29/12; H04L 12/743

(52) U.S. Cl. CPC G06Q 20/401; H04L 61/1511; H04L 45/7453; H04L 61/3065; G06F 17/30377; G06F 21/602; H04L 9/3247

(57) ABSTRACT

Provided herein are methods, networks, systems, and media for providing global naming services with blockchains without a centralized server.

### CROSS-REFERENCE TO RELATED APPLICATIONS

This application claims the benefit of U.S. application Ser. No. 62/296,002, filed Feb. 16, 2016, the entire contents of which are hereby incorporated by reference.

### BACKGROUND

Naming systems, like Domain name systems (DNS), are widely used in computer networks. DNS provides naming services via centralized servers with large central databases. The naming services are provided for computing devices or any resource (e.g., printers, routers, etc.) connected to a computer network, such as the Internet or a private network. DNS associates various information with domain names assigned to participating devices. DNS translates domain names to numerical IP addresses to locate and identify computing devices with underlying networking protocols. DNS services are widely used in various fields, e.g., email exchanges, webpage exploration, file transfer, and financial transactions.

Zooko Wilcox-O'Hearn claims that any naming system can only fulfill two of the following three desirable properties: (1) Secure, i.e., globally unique, wherein here is only one, unique and specific entity to which the name maps and nobody can successfully pretend to be the owner of someone else's domain name; (2) Decentralized, wherein there is no centralized authority for determining the meaning of a name; and (3) Human-meaningful, wherein names are arbitrarily chosen strings short enough for humans to memorize; The three properties, collectively called Zooko's Triangle, leave three possible choices to implement a naming system: (1) Compromise decentralization, e.g., DNSSEC is secure and human-meaningful, but not decentralized, which is implemented with digitally signed records for DNS lookups using public-key cryptography; (2) Compromise human-readability, e.g., Tor .onion and Bitcoin addresses are secure and decentralized, but not human-meaningful, because the name is just a hashed representation of a public key; and (3) Compromise security or integrity, e.g., petname systems, which are human-meaningful and decentralized, but not secure, as locally defined names are not globally unique.

### SUMMARY

There is a long-felt and unmet need for a naming system that simultaneously satisfies the three properties (secure, decentralized, and human-readable) as alternatives to traditional DNS. An exemplary digital currency, Bitcoin, utilizes cryptographic technologies on a peer-to-peer (P2P) network to execute transactions. Digital currencies relying on cryptographic technologies are also called cryptocurrencies; examples of cryptocurrencies include, but not limited to, Bitcoin, Ethereum, Zcash, Litecoin, Namecoin, and Peercoin. Most cryptocurrency technologies are derived from Bitcoin technologies, which create a naming system with security and decentralization. As long as an improvement on top of the Bitcoin technologies can handle human-readability, the improvement holds promise for creating a naming system achieving the three properties of Zooko's Triangle: security, human-readability, and decentralization.

Cryptocurrency technologies are centered at a blockchain. A blockchain is a transaction database that records every transaction ever executed. Every computing node connected to a cryptocurrency's peer-to-peer (P2P) network maintains a full copy of the blockchain. Therefore, by analytically traversing the chain of transactions, the computing node can find out how many coins belong to a name address at any point in history.

A cryptocurrency transaction is a cryptographically signed message that transfers certain amounts of coins from one or more previous transactions to one or more addresses. Each address is a representation of the public key of a private-public keypair. The private key of such a keypair is used to sign transaction messages that transfer coins from the corresponding address. The signed transaction is then broadcasted to every node of the cryptocurrency network. Everyone can then verify the authenticity of the transaction using the public key from the sender's address.

Transactions of cryptocurrencies are collected into blocks. A new block includes several recent transactions that have not yet been written into the existing blockchain. Once a new block is created it is broadcasted and appended to the blockchain and, after getting enough confirmations, becomes part of the. cryptocurrency's history, which means that it will never be changed or removed again, so the transactions of this block become “confirmed transactions.” Every block in the blockchain contains a reference to its previous block, thus creating a chain from the first block (genesis block) to the current one. The block-reference is a cryptographic hash of the previous block. This ensures the integrity of the chain, as any modification to a block would result in a different hash for the block and thus the reference in the next block would change, resulting in a different hash for every block after.

The process of creating a block and appending it to the blockchain is called mining. For proof-of-work based blockchains like Bitcoin, this is a computationally intensive process that requires solving a unique and difficult math problem so that the number of blocks mined each day remains steady. The math problem to solve is used as a proof-of-work, as it is easy to check whether a solution is valid, but it is difficult to find a solution, as this requires a lot of trial and error. In Bitcoin, a proof-of-work scheme is SHA-256, which means that the SHA-256 hash of a block's header must be lower than or equal to a specific target value in order for the block to be valid.

Namecoin shares underlying technologies with other cryptocurrencies, such as Bitcoin. The uniqueness of Namecoin is its implementation of additional types of transactions and RPC (remote procedure call) processes that allow its users to record and transfer arbitrary names (keys) and attach data (values) to those keys in the blockchain. Names are registered and transferred by sending special transactions. Names in Namecoin are secure and decentralized (as they are stored in the blockchain, so every node can check the validity of the operations on a name) and globally unique and human-meaningful (as they can be arbitrarily chosen); they fulfill all three properties of Zooko's triangle and thus allow Namecoin to act as a decentralized naming system.

For example, by registering a name in the “id/” namespace users could use the Namecoin naming system to create online identities and with the help of an online service like NameID turn this Namecoin identity into an OpenID, which can then be used to sign into millions of OpenID-enabled websites. Namecoin's biggest and most popular namespace is however the domain namespace “d/” which can be used to register and manage domain names for the virtual top level domain (TLD) “.bit”. The “.bit” domain is not recognized by ICANN and does not work on the traditional DNS. A summary of Namecoin namespaces is shown below:
“id/” namespace, which is public online identity system (e.g., addresses for Bitcoin, Namecoin, email, etc.).
“p/” namespace, which is personal namespace for PGP, SSL, identities, etc.
“m/” namespace, which is a messaging system for Namecoin users.
“a/”, namespace, which is an alias system to map a name to another address.
“tor/” namespace, which is domain names for .tor TLD for onion websites.

Nevertheless, the inventors of the technologies disclosed herein identify multiple deficiencies in Namecoin technologies, including those described below. The decentralized nature of blockchain-based naming introduces meaningful security benefits, but certain aspects of contemporary blockchains present technical limitations. (1) Limited Storage. Individual blockchain records are typically on the order of kilobytes and cannot hold much data. (2) Limited Bandwidth. Latency of creating/updating records is capped by the blockchain's write propagation and leader election protocol and is typically in the order of 10-40 minutes. The total new operations in each round are limited by average bandwidth of nodes participating in leader election (in cases of Bitcoin and Namecoin the current bandwidth per new round is 1 MB). (3) Linear Bootup Time. Further, new nodes need to independently audit the global log from the beginning and as the system makes forward progress the time to bootstrap new nodes increases linearly. As such, the technologies disclosed herein can work on any blockchain and are designed to offer unlimited storage, off-chain operations, short bootup time, and ability to migrate to the most secure blockchain.

The security of name ownership is tied to the security of both the underlying blockchain and the software powering it. There are three security issues to consider. (1) Cost of Attack. Miners often pool their resources to form a mining pool, which is essentially a super node on the network (a lot of computational power behind a single miner node). If the amount of computational power under the control of a single miner (or pool) is more than the rest of the network, then that miner has the ability to attack the network and rewrite recent blockchain history, censor transactions (e.g., for name registrations), and steal cryptocurrency using double spend attacks (which is known as a 51% attack). This is because the miner will win the leader election majority of the time, and produce a blockchain history with more proof-of-work than any disagreeing miner. The more expensive it is to have majority compute power on a particular blockchain, the more secure the blockchain. (2) Software Vulnerabilities. Raw hashing power is not the only metric for the security of a blockchain. Software issues/bugs are also very important, e.g., in 2013, a bug in Namecoin allowed people to steal names from anyone. Actively developed codebases with frequent security reviews lower the rate of critical bugs in production. (3) DDoS Attacks. One of the less explored security issues with cryptocurrency blockchains is network attacks, e.g., DDoS attack on core discovery nodes, mining pools, or the entire network. The more peers a cryptocurrency network has, the more resilient the network is to denial of service attacks. As such, the technologies disclosed herein are designed to handle this security issue by operating on the most secure blockchain that is available at any given time as measured by cost of attack, software stability, and size and resilience of the peer network.

Besides identified security issues, the inventors of the technologies disclosed herein identified that network reliability is a concern as well. The throughput of a naming system (number of entries a system can register/update) is directly dependent on the throughput of the underlying blockchain. The number of new register/update operations that can be performed per hour is limited by the number of transactions that can be sent (and confirmed) on the underlying blockchain per hour. Similarly, reliability of a naming system is impacted if the underlying blockchain cannot perform operations reliably and consistently. (1) Network Latency Spike. In an analysis, the Namecoin network has a 10 minute target of writing new blocks (latency target) and a 1 MB bandwidth limit on block size (giving throughput of 1000 transactions per block). However, a network latency spike can take place; for example, someone on the network sends transactions with a large number of data fields per transaction. This causes severe performance problems for the miners. Thus, the technologies disclosed herein are developed to handle latency spikes and unexpected protocol issues by operating on the blockchain that has the most reliable network. (2) Network Throughput Drop. In various periods of monitoring, Namecoin transactions were not getting accepted for many consecutive blocks and then, after a while, get accepted in bulk in a single block that packaged a lot of transactions. In some cases, the network throughput goes down because of no transactions in new blocks. Thus, the technologies disclosed herein are designed to be able to handle the issue of network throughput drop issues by operating on the blockchain that has the most reliable network.

Another issue noted by the inventors of the technologies disclosed herein is regarding software upgrades of cryptocurrency network nodes. For updates to name pricing or other major changes, Namecoin network requires a “hard fork” in which everyone on the network must upgrade their software, and nodes on previous versions can no longer participate in the blockchain network. Anecdotal evidence suggests that it's hard to get miners to upgrade their software because they don't have enough incentive to spend engineering hours on maintaining a small cryptocurrency like Namecoin, which is not their main reason for operating a mining pool. In experiments involving monitoring the Namecoin network, the inventors of the technologies disclosed herein showed that whenever software updates were issued on Namecoin, there was a considerable fluctuation of computing power. Notable are that after the recent upgrade to Namecoin Core, a major upgrade to the Namecoin software, many miners dropped out and never came back online. As such, the technologies disclosed herein are designed to handle software upgrade issues by handling most functionality in a separate layer on top of the underlying blockchain; the system design includes a virtual blockchain on top of the underlying blockchain that separates higher layer upgrades, e.g., upgrades to the naming system, from cryptocurrency upgrades. Cryptocurrency miners don't need to upgrade their software if anything in the higher layer changes, minimizing their cost (engineering time) of software upgrades. This enables the naming system to run on the most secure blockchain without requiring explicit upgrades from the underlying blockchain.

Another issue noted by the inventors of the technologies disclosed herein is regarding failure of “merged mining.” Security of a blockchain depends on relative compute power that miners have and how much would it cost a single party to get more computing power than the rest of the network. New, smaller blockchains have a bootstrapping problem where in the initial days of a new blockchain it would be relatively easy for a single party to take it over, since the total compute power on the blockchain is not yet large enough to prevent this. To address this problem, a system comprises “merged mining” where an alternate blockchain can allow miners to participate in the new network without requiring them to spend extra compute cycles. The miners can make extra profits on the new blockchain without adding computational overhead. With a merge-mined cryptocurrency the security of the blockchain is typically a subset of the “main blockchain,” because in practice not all miners of the main blockchain go through the trouble of setting up merged mining. Namecoin switched to merged mining with Bitcoin to increase security of the blockchain. Namecoin is the oldest and largest merged-mined cryptocurrency and inspired other cryptocurrencies to consider it as well. However, a key finding found by the inventors of the technologies disclosed herein is that merged mining is currently failing in practice in Namecoin, which is vulnerable to the 51% attack, see aforementioned descriptions. Moreover, merged-mining provided a false sense of security to the Namecoin community. Unless the merged mined cryptocurrency is able to consistently get a very high ratio of main blockchain miners to support their software, merged mining will not keep it safe from 51% attacks. The merged mining failure suggests that we're at a stage in the evolution of blockchains where there is not yet enough compute cycles dedicated to mining to support multiple secure blockchains. Thus, the technologies disclosed herein are designed to handle merged mining issue by operating on the most secure blockchain instead of a merged-mined blockchain.

In view of the merits of cryptocurrency technologies, the technologies disclosed herein create a global naming system based on the blockchain technologies on a computer network without centralized servers. Further, the technologies are designed to address the aforementioned issues. First, the technologies create a naming system satisfying three properties of Zooko's Triangle. Second, the technologies separate control plane from data plane, where the control plane stores limited control data in order to facilitate control analysis and the data plane offers unlimited data storage. Third, the control plane comprises a virtual blockchain which is filtered or derived from an underlying blockchain; the use of the virtual blockchain allows the system to be agnostic of the underlying blockchain, and therefore enhances security. Further, the system based on virtual blockchains has a migratory capability; when an underlying blockchain encounters network reliability issues, the system can be migrated to another underlying blockchain (e.g., migrating from Namecoin to Bitcoin or to another non-financial network) without interfering with the naming mechanisms. In addition, the system based on virtual blockchains becomes an agile system, which allows software updates to be performed on only a higher-layer functionality which is a small portion of the computer code and miners don't need to run that software. Therefore, it's much easier to do software upgrades as it involves less parties and no upgrade is necessary for the underlying blockchain.

In one aspect, disclosed herein are methods for processing a global naming system with blockchains on a computer network, the method comprising: (a) accessing and processing an underlying blockchain, the underlying blockchain comprising existing transactions; (b) storing data records in one or more data storage units inside and/or outside of the underlying blockchain, wherein the data records comprise routing information; (c) issuing a new transaction on the underlying blockchain; (d) deriving a virtual blockchain by processing the existing transactions in the underlying blockchain and interpreting the existing transactions as a set of virtual blockchain operations; (e) creating first binding data between a name, a cryptographic keypair, and a bytestring (for example a record or record hash) by processing operations in the virtual blockchain, wherein the operations comprise registrations, data record updates, and name transfers; and (f) updating the first binding data by processing new operations in the virtual blockchain; whereby a domain name service is provided without a centralized server. In some embodiments, a user is allowed to enter the name to be registered. In some embodiments, the name is unique. In some embodiments, the name comprises a human-meaningful name, or an automatically generated, or both. In some embodiments, the name is picked by a human. In some embodiments, the bytestring comprises a record hash and the method further comprises deriving second binding data of the name to the data records based on combining the name to the first binding data with lookups in the one or more data storage units that map the record hash to a hash deriving record, wherein the record hash is derived from the hash deriving record. In some embodiments, a user is allowed to enter routing information in a said data record. In some embodiments, a user is allowed to generate a cryptographic keypair comprising a public key and a private key, or a set of keys, or a derivation thereof. In some embodiments, the one or more data storage units are located at a remote site, or at a local site, or both. In further embodiments, the one or more data storage units are distributed on the computer network. In still further embodiments, the one or more data storage units are further configured to store one or more of the following: the first binding data, the mapping information between the record hash and the hash deriving record, and a distributed hash table. In some embodiments, the data records comprise one or more of the following: data of the user, a profile of the user, a user identifier, a first name, a last name, a web address, a position, an employer, a street address, a city, a state, a country, a uniform resource locator, and one or more transactions of a digital currency. In further embodiments, the data records are signed by a cryptographic key, or a private key of the user. In some embodiments, the first biding data is generated based on a cryptographic key pair. In further embodiments, the method comprises defining a protocol to associate an ownership of the name with the user. In still further embodiments, the protocol comprises a cryptographic protocol to associate an ownership of the name with the user, or a cryptographic protocol to associate an ownership of the name with the user based on a pair of a private key and a public key. In some embodiments, the method further comprises accessing the data records stored in the one or more data storage units. In some embodiments, the method further comprises authenticating the data records retrieved from the one or more data storage units. In some embodiments, the method further comprises associating the virtual blockchain with a second underlying blockchain. In some embodiments, the method further comprises writing a new data record into the one or more data storage units. In some embodiments, the method further comprises updating the data records stored in the one or more data storage units. In some embodiments, the method further comprises allowing a user to preorder the name. In some embodiments, the method further comprises allowing a user to register the name. In some embodiments, the method further comprises one or more of the following: transferring the name, updating the name, and revoking the name. In some embodiments, the method further comprises processing consensus by one or more computing devices on the computer network. In further embodiments, the processing consensus comprises analyzing a global state of a block in the underlying blockchain. In still further embodiments, analyzing the global state comprises one or more of the following: analyzing one or more operations in the virtual blockchain, analyzing a state change, and using a bootstrapping algorithm. In some embodiments, the method further comprises using a simplified name verification process. In some embodiments, the method further comprises calculating a price of name registration based on one or more characteristics of the name. In further embodiments, the one or more characteristics of the name comprise one or more of the following: a length of the name, and popularity of the name. In some embodiments, the computer network comprises a peer-to-peer network. In some embodiments, the steps are completed by one or more computing devices on the computer network.

In another aspect, disclosed herein are computer networks for processing a global naming system with blockchains, the network comprising: (a) a plurality of computing devices, wherein each said computing device comprises a processor, a memory module, and an operating system; and the plurality of the computing devices communicates based on a peer-to-peer protocol; and (b) one or more data storage units being located inside and/or outside of an underlying blockchain and configured to store data records comprising routing information; wherein (1) one of said computing devices accesses and processes the underlying blockchain, the underlying blockchain comprising existing transactions; (2) one of said computing devices issues a new transaction on the underlying blockchain; (3) one of said computing devices derives a virtual blockchain by processing the existing transactions in the underlying blockchain and interpreting the existing transactions as a set of virtual blockchain operations; (4) one of said computing devices creates first binding data between a name, a cryptographic keypair, and a bytestring (for example a record or record hash) by processing operations in the virtual blockchain, wherein the operations comprise registrations, data record updates, and name transfers; and (5) one of said computing devices updates the first binding data by processing new operations in the virtual blockchain; whereby a domain name service is provided without a centralized server. In some embodiments, a user is allowed to enter the name to be registered. In some embodiments, the name is unique. In some embodiments, the name comprises a human-meaningful name. In further embodiments, the name is automatically generated or picked by a human. In some embodiments, the bytestring is a record hash and one of said computing devices derives second binding data of the name to the data records based on combining the name to the first binding data with lookups in the one or more data storage units that map the record hash to a hash deriving record, wherein the record hash is derived from the hash deriving record. In some embodiments, a user is allowed to enter routing information in a said data record. In some embodiments, a user is allowed to generate a cryptographic keypair comprising a public key and a private key, or a set of keys, or a derivation thereof. In some embodiments, the one or more data storage units are located at a remote site, or at a local site, or both. In some embodiments, the one or more data storage units are distributed on the computer network. In some embodiments, the one or more data storage units are further configured to store one or more of the following: the first binding data, the mapping information between the record hash and the hash deriving record, and a distributed hash table. In some embodiments, the data records comprise data of the user. In some embodiments, the data records comprise one or more of the following: a profile of the user, a user identifier, a first name, a last name, a web address, a position, an employer, a street address, a city, a state, a country, a uniform resource locator, and one or more transactions of a digital currency. In some embodiments, the data records are signed by a cryptographic key. In further embodiments, the data records are signed by a public/private key of the user. In some embodiments, the first biding data is generated based on a cryptographic key pair. In some embodiments, one said computing device defines a protocol to associate an ownership of the name with the user. In further embodiments, one said computing device defines a cryptographic protocol to associate an ownership of the name with the user. In still further embodiments, one said computing device defines a cryptographic protocol to associate an ownership of the name with the user based on a pair of a private key and a public key. In some embodiments, one said computing device accesses the data records stored in the one or more data storage units. In some embodiments, one said computing device authenticates the data records retrieved from the one or more data storage units. In some embodiments, one said computing device associates the virtual blockchain with a second underlying blockchain. In some embodiments, one said computing device writes a new data record into the one or more data storage units. In some embodiments, one said computing device updates the data records stored in the one or more data storage units. In some embodiments, one said computing device allows a user to do one or more of the following: preorder the name, register the name, transfer the name, update the name, and revoke the name. In some embodiments, one said computing device processes consensus by one or more computing devices on the computer network. In further embodiments, one said computing device processes consensus by analyzing a global state of a block in the underlying blockchain. In still further embodiments, analyzing the global state comprises analyzing one or more operations in the virtual blockchain, or analyzing a state change, or both. In additional embodiments, the analyzing the global state comprises a use of a bootstrapping algorithm. In some embodiments, one said computing device uses a simplified name verification process. In some embodiments, one said computing device calculates a price of name registration based on one or more characteristics of the name. In some embodiments, one or more characteristics of the name comprise one or more of the following: a length of the name, and popularity of the name.

In yet another aspect, disclosed herein are computing systems on a computer network for processing a global naming service with blockchains, the system comprising: (a) a processor, a memory module and an operating system configured to execute machine readable instructions; (b) one or more data storage units configured to store data records, wherein the one or more data storage units are inside and/or outside of an underlying blockchain and the data records comprise routing information; and (c) a computer program comprising instructions executed by the processor to create an application without using a centralized server, the application comprising: (1) a software module configured to access and process the underlying blockchain, the underlying blockchain comprising existing transactions; (2) a software module configured to issue a new transaction on the underlying blockchain; (3) a software module configured to derive a virtual blockchain by processing the existing transactions in the underlying blockchain and interpreting the existing transactions as a set of virtual blockchain operations; (4) a software module configured to create first binding data between a name, a cryptographic keypair, and a bytestring (for example a record or record hash) by processing operations in the virtual blockchain, wherein the operations comprise registrations, data record updates, and name transfers; and (5) a software module configured to update the first binding data by processing new operations in the virtual blockchain; whereby a domain name service is provided without a centralized server on the network. In some embodiments, the application further comprises a software module configured to allow a user to enter the name to be registered. In some embodiments, the name is unique. In further embodiments, the name comprises a human-meaningful name. In still further embodiments, the name is automatically generated, or picked by a human. In some embodiments, the bytestring is a record hash and the application further comprises a software module configured to derive second binding data of the name to the data records based on combining the name to the first binding data with lookups in the one or more data storage units that map the record hash to a hash deriving record, wherein the record hash is derived from the hash deriving record. In some embodiments, the application further comprises a software module configured to allow a user to enter routing information in a said data record. In some embodiments, a user is allowed to generate a cryptographic keypair comprising a public key and a private key, or a set of keys, or a derivation thereof. In some embodiments, the one or more data storage units are located at a remote site, or at a local site, or both. In some embodiments, one or more data storage units are distributed on the computer network. In some embodiments, the one or more data storage units are further configured to store the first binding data. In some embodiments, the one or more data storage units are further configured to store the mapping information between the record hash and the hash deriving record. In some embodiments, the one or more data storage units are further configured to store a distributed hash table. In some embodiments, the data records comprise data of the user. In some embodiments, the data records comprise one or more of the following: a profile of the user, a user identifier, a first name, a last name, a web address, a position, an employer, a street address, a city, a state, a country, a uniform resource locator, and one or more transactions of a digital currency. In further embodiments, the data records are signed by a cryptographic key. In still further embodiments, the data records are signed by a public key of the user. In some embodiments, the first biding data is generated based on a cryptographic key pair. In some embodiments, the application further comprises a software module configured to define a protocol to associate an ownership of the name with the user. In further embodiments, the application further comprises a software module configured to define a cryptographic protocol to associate an ownership of the name with the user. In still further embodiments, the application further comprises a software module configured to define a cryptographic protocol to associate an ownership of the name with the user based on a pair of a private key and a public key. In some embodiments, the application further comprises a software module configured to access the data records stored in the one or more data storage units. In some embodiments, the application further comprises a software module configured to authenticate the data records retrieved from the one or more data storage units. In some embodiments, the application further comprises a software module configured to associate the virtual blockchain with a second underlying blockchain. In some embodiments, the application further comprises a software module configured to write a new data record into the one or more data storage units. In some embodiments, the application further comprises a software module configured to update the data records stored in the one or more data storage units. In some embodiments, the application further comprises a software module configured to allow a user to do one or more of the following: preorder the name, register the name, transfer the name, update the name, and revoke the name. In some embodiments, the application further comprises a software module configured to process consensus. In further embodiments, the application further comprises a software module configured to process consensus by analyzing a global state of a block in the underlying blockchain. In still further embodiments, analyzing the global state comprises: analyzing one or more operations in the virtual blockchain, or analyzing a state change, or both. In some embodiments, analyzing the global state comprises a use of a bootstrapping algorithm. In some embodiments, the application further comprises a software module configured to use a simplified name verification process. In some embodiments, the application further comprises a software module configured to calculate a price of name registration based on one or more characteristics of the name. In some embodiments, the one or more characteristics of the name comprise one or more of the following: a length of the name, and popularity of the name. In some embodiments, the computer network comprises a peer-to-peer network.

In yet another aspect, disclosed herein are non-transitory computer readable medium storing machine readable instructions executed by the processor to create an application for processing a global naming system with blockchains, the application comprising: (a) a software module configured to store data records in one or more data storage unites, wherein the one or more data storage units are inside and/or outside of an underlying blockchain and the data records comprises routing information; (b) a software module configured to access and process the underlying blockchain, the underlying blockchain comprising existing transactions; (c) a software module configured to issue a new transaction on the underlying blockchain; (d) a software module configured to derive a virtual blockchain by processing the existing transactions in the underlying blockchain and interpreting the existing transactions as a set of virtual blockchain operations; (e) a software module configured to create first binding data between a name, a cryptographic keypair, and a bytestring (for example a record or record hash) by processing operations in the virtual blockchain, wherein the operations comprise registrations, data record updates, and name transfers; and (f) a software module configured to update the first binding data by processing new operations in the virtual blockchain; whereby a domain name service is provided without a centralized server on the network. In some embodiments, the application further comprises a software module configured to allow a user to enter the name to be registered. In some embodiments, the name is unique. In further embodiments, the name comprises a human-meaningful name. In still further embodiments, the name is automatically generated, or picked by a human. In some embodiments, the bytestring is a record hash and the application further comprises a software module configured to derive second binding data of the name to the data records based on combining the name to the first binding data with lookups in the one or more data storage units that map the record hash to a hash deriving record, wherein the record hash is derived from the hash deriving record. In some embodiments, the application further comprises a software module configured to allow a user to enter routing information in a said data record. In some embodiments, a user is allowed to generate a cryptographic keypair comprising a public key and a private key, or a set of keys, or a derivation thereof. In some embodiments, the one or more data storage units are located at a remote site, or at a local site, or both. In some embodiments, one or more data storage units are distributed on the computer network. In some embodiments, the one or more data storage units are further configured to store the first binding data. In some embodiments, the one or more data storage units are further configured to store the mapping information between the record hash and the hash deriving record. In some embodiments, the one or more data storage units are further configured to store a distributed hash table. In some embodiments, the data records comprise data of the user. In some embodiments, the data records comprise one or more of the following: a profile of the user, a user identifier, a first name, a last name, a web address, a position, an employer, a street address, a city, a state, a country, a uniform resource locator, and one or more transactions of a digital currency. In further embodiments, the data records are signed by a cryptographic key. In still further embodiments, the data records are signed by a public key of the user. In some embodiments, the first biding data is generated based on a cryptographic key pair. In some embodiments, the application further comprises a software module configured to define a protocol to associate an ownership of the name with the user. In further embodiments, the application further comprises a software module configured to define a cryptographic protocol to associate an ownership of the name with the user. In still further embodiments, the application further comprises a software module configured to define a cryptographic protocol to associate an ownership of the name with the user based on a pair of a private key and a public key. In some embodiments, the application further comprises a software module configured to access the data records stored in the one or more data storage units. In some embodiments, the application further comprises a software module configured to authenticate the data records retrieved from the one or more data storage units. In some embodiments, the application further comprises a software module configured to associate the virtual blockchain with a second underlying blockchain. In some embodiments, the application further comprises a software module configured to write a new data record into the one or more data storage units. In some embodiments, the application further comprises a software module configured to update the data records stored in the one or more data storage units. In some embodiments, the application further comprises a software module configured to allow a user to do one or more of the following: preorder the name, register the name, transfer the name, update the name, and revoke the name. In some embodiments, the application further comprises a software module configured to process consensus. In further embodiments, the application further comprises a software module configured to process consensus by analyzing a global state of a block in the underlying blockchain. In still further embodiments, analyzing the global state comprises: analyzing one or more operations in the virtual blockchain, or analyzing a state change, or both. In some embodiments, analyzing the global state comprises a use of a bootstrapping algorithm. In some embodiments, the application further comprises a software module configured to use a simplified name verification process. In some embodiments, the application further comprises a software module configured to calculate a price of name registration based on one or more characteristics of the name. In some embodiments, the one or more characteristics of the name comprise one or more of the following: a length of the name, and popularity of the name. In some embodiments, the computer network comprises a peer-to-peer network.

In yet another aspect, disclosed herein are computer-implemented methods of using an authentic record in a blockchain to determine authenticity of an older record in the blockchain on a computer network, the method comprising: (a) generating a new record comprising a block number and a cryptographic hash, wherein the block number is a number of blocks in a blockchain at a time when the new record is created; (b) appending the new record to an end of the blockchain, wherein the new record and existing records in the blockchain are stored as a sequence of transactions in the blockchain and are grouped into blocks; (c) deriving a second cryptographic hash for a first block from a first cryptographic hash of records in the first block and previously-calculated cryptographic hashes of a geometric sequence of prior blocks; (d) selecting records from the first block to derive the second cryptographic hash in the step (c), wherein the records are associated with block numbers within a fixed range of the first block's blockchain-determined number; (e) deriving the geometric sequence of prior blocks as blocks separated by exponentially increasing intervals, starting from block number and decreasing; (f) deriving a skip-list of blocks, such that directed edges originating from a block point to the prior blocks used to derive the second cryptographic hash; (g) querying the first block's records by using the second cryptographic hash of the first block with a greater block number and traversing the skip list; (h) traversing the skip list by re-calculating the second cryptographic hash for each visited block and verifying that the re-calculated cryptographic hash matches a cryptographic hash of an already-visited block; (i) authenticating an earlier record by using an authenticated record with a larger block number by querying the earlier record's block; whereby a name ownership verification service is provided that removes the need for the verifying computer to trust a central authority or first obtain a full copy of the blockchain.

The technologies disclosed herein are not limited to digital currency processing. They are well-suited for building secure, decentralized services, which can be further applied to not only financial data processing in general but also non-financial data processing such as military, academic, health care, travel, enterprise resource planning, etc. Therefore, a person skilled in the art, in light of the disclosure provided herein, will recognize that the technologies are readily applied to many fields.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an exemplary system architecture;

FIG. 2 illustrates an exemplary system architecture with external storage units;

FIG. 3 illustrates an exemplary name registration process;

FIG. 4 illustrates an exemplary software architecture;

FIG. 5 illustrates an exemplary software architecture with four logic layers constructing a naming system;

FIG. 6 illustrates an exemplary blockchain analysis;

FIG. 7 illustrates an exemplary simplified name verification process;

FIG. 8 illustrates an exemplary fork analysis;

FIG. 9 illustrates an exemplary system peer and backup peer deployments;

FIG. 10 illustrates an exemplary processing flow for name value lookup; and

FIG. 11 illustrates an exemplary processing flow for simplified name verification.

### DETAILED DESCRIPTION OF THE INVENTION

As described herein, a database storing data transactions such as cryptocurrency blockchains and their respective peer-to-peer (P2P) networks is optionally used to provide a naming system. Cryptocurrency blockchains provide cryptographically auditable, append-only ledgers that are already being used to build new, decentralized versions of DNS and public-key infrastructure, along with other applications like file storage and document timestamping. On a P2P network, shared databases (e.g., blockchains) storing transaction data have no central points of trust or failure, they enable a new class of decentralized applications and services that minimize the degree to which users need to put complete trust in a single party, like a DNS root server or a root certificate authority.

The technologies disclosed herein utilize blockchains for building decentralized systems and applications. Many non-financial applications of blockchains imply the need for a naming system that securely binds unique keys, which can be human-readable, to arbitrary values. The blockchain gives consensus on the global state of the naming system and provides an append-only global log for any state changes. New writes and updates to name/value pairs can only be announced in new blocks, as appends to the global log. The global log is logically centralized (all nodes on the network see the same state), but organizationally decentralized (no central party controls the log).

### Naming System Overview

In various embodiments, the networks, systems, media, and methods described herein create a global naming system based on blockchains without using a centralized server.

In some embodiments, a naming system means that (1) names are human-readable and can be picked by humans, (2) name/value pairs have strong sense of ownership—that is, they can be owned by cryptographic keypairs, and (3) there is no central trusted party or point of failure. Building a naming system with these three properties was considered impossible according to Zooko's Triangle and most naming systems provide two out of these three properties. However, the technologies disclosed based on a blockchain-based approach to provide a naming system that offered all three properties: human readability, strong ownership, and decentralization without modifying the underlying blockchain.

Blockchains provide a global append-only log that is publicly writeable. Writes to the global log, called transactions, are organized as blocks and each block packages multiple transactions into a single atomic write. Writing to the global log requires a payment in the form of a transaction fee. Nodes participating in a blockchain network follow a leader election protocol for deciding which node gets to write the next block and collect the respective transaction fees. Not all nodes in the network participate in leader election. Nodes actively competing to become the leader of the next round are called miners. At the start of each round, all miners start working on a new computation problem, derived from the last block, and the miner that is the first to solve the problem gets to write the next block. In the embodiments with Bitcoin, the difficulty of these computation problems is automatically adjusted by the protocol to roughly get 1 new block every 10 minutes.

Creating an alternate DNS-like system that replaces DNS root servers with a blockchain for storing information on registered domain names is a subject matter of the instant technologies. Given that blockchains don't have central points of trust, a blockchain-based DNS is much harder to censor and registered names cannot be seized from owners without getting access to their respective private keys. Altering name registrations stored in a blockchain requires prohibitively high computing resources because re-writing blockchain data requires proof-of-work.

The technologies disclosed herein provide support for registering name/value pairs. The technologies implement name registration functionality as a separate layer on top of a cryptocurrency, such as Bitcoin. Just like DNS, there is a cost associated with registering a new name. The name registration fee discourages people from grabbing a lot of names that they don't intent to actually use. In some embodiments, a system defines a pricing function for how cost of name registrations change over time. In some embodiments, a system supports multiple namespaces (like TLDs in DNS), and the different rules for pricing and name expiration apply to different namespaces. In Namecoin, same rules for pricing and name expiration are used across all namespaces. In Namecoin, the “d/” namespace is used for domain names. For example, to register the domain “yahoo” on a system, one must register the name “d/yahoo” and then put the IP address of the Yahoo! website in the name/value pair. The technologies disclosed herein allow for separate rules and separate pricing functions for each namespace.

In some embodiments, name registration is a two-step process. A user first pre-orders a name in a new transaction that includes hash(name) in the transaction. This does not reveal what name the user is trying to register. After the preorder transaction has been confirmed by the network, i.e., enough blocks (e.g., 10 blocks) are later added to the blockchain to make it computationally infeasible for any miner to re-write recent blockchain history and reverse the transaction, the user can reveal the name he/she was actually trying to register. This is done by sending a second transaction on the network and completes the registration step. The user includes the value of the name/value pair in the second transaction as well. An address that signed the two transactions becomes the owner of the newly registered name/value pair. Name registrations expire after a fixed amount of time, measured in new blocks written (e.g., the expiry time can be 36,000 blocks, roughly 8 months with 10 minute block window). The system also supports updating the value associated with a name, and ownership transfers.

In some embodiments, a system starts a new namespace on a cryptocurrency, such as “u/” on Namecoin. A format for publishing public-keys, like PGP, along with other profile data in the blockchain is defined. This is similar to the format of DNS records. In some embodiments, a system comprises a web service to allow users to easily register names on the u/ namespace of a cryptocurrency and associate profile data with the names. The web service first registers the name on the user's behalf (and also cover the cost of name registration for them) and then transfers the name to a cryptocurrency address owned by the user. In some embodiments, implementation is based on a PKI system that binds user identities to public-keys using a blockchain. In additional embodiments, one or more registered names have a ECDSA public-key binding by default, and a subset of users added their PGP keys as well.

The technologies disclosed herein build a naming system as a separate logical layer on top of the underlying blockchain. A system uses the underlying blockchain to achieve consensus on the state of this naming system. It uses the underlying blockchain as a communication channel for announcing state changes; any changes to the state of the naming system can only be announced in new blockchain blocks. Relying on the consensus protocol of the underlying blockchain, a system gives total ordering for all operations (like register, update, and transfer) supported by the naming system.

The technology disclosed herein introduces new functionality on top of blockchains by defining a set of new operations that are otherwise not supported by the underlying blockchain. In some embodiments, a system has four layers, with two layers (underlying blockchain and virtual blockchain) in the control plane and two layers (routing and storage) in the data plane. Details of the layers are described below.

For ease of the following descriptions, the technologies disclosed herein are collectively called a Blockstack in the instant disclosure.

### Underlying Blockchain

In various embodiments, the networks, systems, media, and methods described herein include an underlying blockchain, or use of the same. An underlying blockchain occupies the lowest tier of the instant system design, and serves two purposes: it stores the sequence of blockchain operations, and provides consensus on the order in which they were written. Blockchain operations are encoded in transactions on the underlying blockchain.

Examples of underlying blockchains include, but not limited to, Bitcoin, Ethereum, Zcash, Monero, Litecoin, Namecoin, and Peercoin. Other non-financial blockchains are suitable for the technologies disclosed herein.

In various embodiments, the networks, systems, media, and methods described herein are able to access and process an underlying blockchain. In some embodiments, an underlying blockchain comprises existing transactions.

### Virtual Blockchain

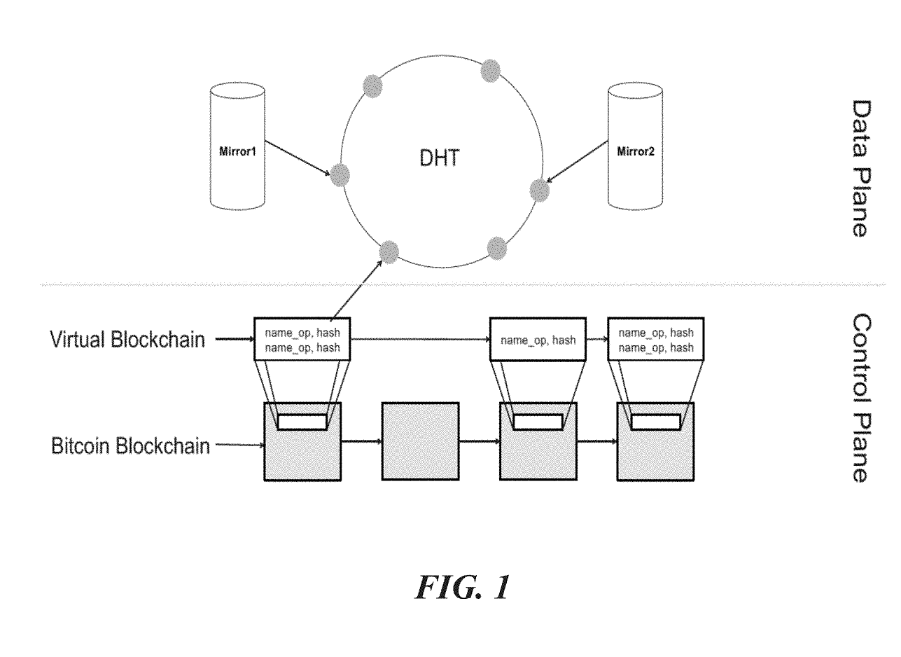

In various embodiments, the networks, systems, media, and methods described herein include a virtual blockchain, or use of the same. Referring to FIG. 1, a virtual blockchain is a logically separate layer on top of an underlying blockchain in a control plane. A virtual blockchain is derived by processing the existing transactions in an underlying blockchain (e.g., a Bitcoin blockchain). In further embodiments, the existing transactions are interpreted as a set of virtual blockchain operations.

In some embodiments, processing operations in a virtual blockchain comprises first creating a binding between a name, a cryptographic keypair, and a record hash. Examples of operations include, but not limited to, registrations, data record updates, and name transfers. In additional embodiments, virtual blockchain processing comprises updating the binding by processing new operations in the virtual blockchain. In certain designs, updating is performed continuously.

In some embodiments, processing of virtual blockchain comprises deriving a second binding between the name and the data records, based on combining the first binding with lookups in the one or more data storage units that map the record hash to a hash deriving record, wherein the record hash is derived from the hash deriving record.

In some embodiments, only computing nodes on a Blockstack network are aware of a virtual blockchain and underlying blockchain nodes are agnostic to it. Blockstack operations are defined in the logic layer of virtual blockchain and are encoded in valid blockchain transactions as additional metadata. Nodes of an underlying blockchain do see the raw transactions, but the logic to process the operations only exists at the virtual blockchain level. In some embodiments, rules for accepting or rejecting Blockstack operations are also defined in the virtual blockchain. Accepted operations are processed by the virtual blockchain to construct a database that stores information on global state of the system along with state changes at any given block of an underlying blockchain. In certain applications, virtual blockchains are used to build a variety of state machines.

A system with a virtual blockchain does not put any limitations on which cryptocurrency blockchain can be used with it. Any blockchain (e.g., Bitcoin, Namecoin, and any non-financial blockchain) can be used. Since processes of a naming system based on a virtual blockchain is independent of the underlying blockchain, the virtual blockchain design holds an ability to migrate from one blockchain to another. The migratory capability allows for a large system to survive, even when the underlying blockchain is compromised.

In some embodiments, the security and reliability properties are directly dependent on an underlying blockchain. However, the migratory capability allows a virtual blockchain to migrate from a first underlying blockchain to a second underlying blockchain when the first underlying blockchain encounters security issues.

In some embodiments, a virtual blockchain constructs a state machine after processing information from the underlying blockchain. In some embodiments, a virtual blockchain treats transactions from the underlying blockchain as inputs to the state machine. Valid inputs trigger state changes. At any given time, where time is defined by the block number, a state machine gives exactly one global state. Time moves forward as new blocks are written in the underlying blockchain and the global state is updated accordingly. In further embodiments, a system defines a state machine that represents the global state of a naming system i.e., who owns a particular name, what data is associated with a name etc. It's possible to use the virtual blockchain concept to define other types of state machines as well.

In some embodiments, transaction processing based on virtual blockchain and based on separation between control and data planes offers a fast write rate by moving some data operations off-chain. Without the technologies disclosed herein, write rate is capped by a blockchain's write propagation and leader election protocol and is pegged to the rate at which new blocks are announced by leader nodes (called miners in blockchain networks).

In some embodiments, the technologies disclosed herein offer bandwidth that is not capped by, and can be orders of magnitude higher than, the bandwidth of the underlying blockchain. In existing technologies, the total number of transactions per block is limited by the block size of a blockchain. To maintain fairness and give all nodes a chance to become leader in the next round, it's required that all nodes receive a newly announced block at roughly the same time. Therefore, the block size is typically limited by average uplink bandwidth of nodes in the network. For example, Bitcoin has a bandwidth of 1 MB (1000 transactions) per new block. However, the technologies disclosed herein uses virtual blockchain to process operations and store data records in a separate data plane, so the total amount of data stored is not limited by the block size of a blockchain.

In some embodiments, the technologies disclosed herein are configured to store a limited ledger. In existing technologies, the integrity of blockchains depends on the ability for anyone to audit them back to the first block. As the system makes forward progress and issues new blocks, the cost of this auditing grows linearly with time and booting up new nodes becomes progressively more time consuming. This is called the endless ledger problem. For example, Bitcoin's blockchain currently has 450,000 blocks and new nodes take 1-3 days to boot up. In contrast, the technologies disclosed herein uses virtual blockchains to process operations and store a leger in a separate data plane, so virtual blockchain processing is deemed to store a limited ledger comprising only the relevant transactions

### External Data Storage Units

In various embodiments, the networks, systems, media, and methods described herein include one or more data storage units, or use of the same. Referring to FIG. 1, in some embodiments, data storage units are external to blockchains. Data storage units are configured to store data records. In additional embodiments, data records are signed by a cryptographic key. In particular embodiments, data records are signed by a private key of the user.

In certain embodiments, data records comprise name records. In certain embodiments, data records comprise one or more of the following user related data: data of the user, a profile of the user, a user identifier, a first name, a last name, a web address, a position, an employer, a street address, a city, a state, a country, and a uniform resource locator. In some designs, data records comprise one or more transactions of a digital currency.

In some embodiments, data storage units are configured to store binding data between a name, a cryptographic keypair, and a record hash. In some embodiments, data storage units are configured to store the mapping information between the record hash and the hash deriving record. In some embodiments, data storage units are configured to store a hash table. In some cases, the hash table comprises a distributed hash table. In other cases, record hashes are stored on a peer-to-peer network where every node has a full copy of all the records.

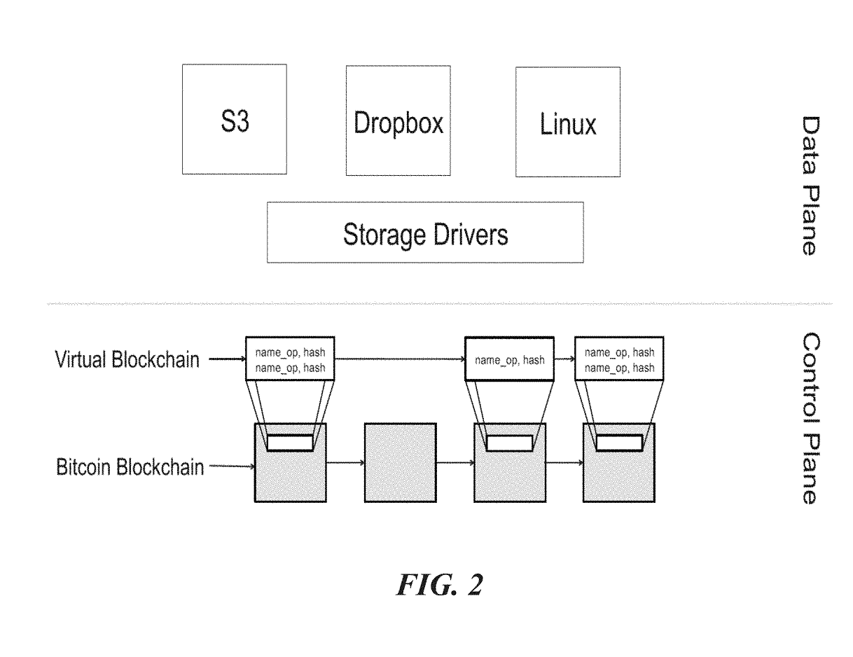

Many external data storages are suitable. Referring to FIG. 2, examples of suitable external data storages include, by way of non-limiting examples, Amazon S3, Dropbox, IPFS, or Syndicate. In certain embodiments, data storage units are located at a remote site. In several embodiments, data storage units are located at a local site. In particular embodiments, data storage units are distributed on a computer network.

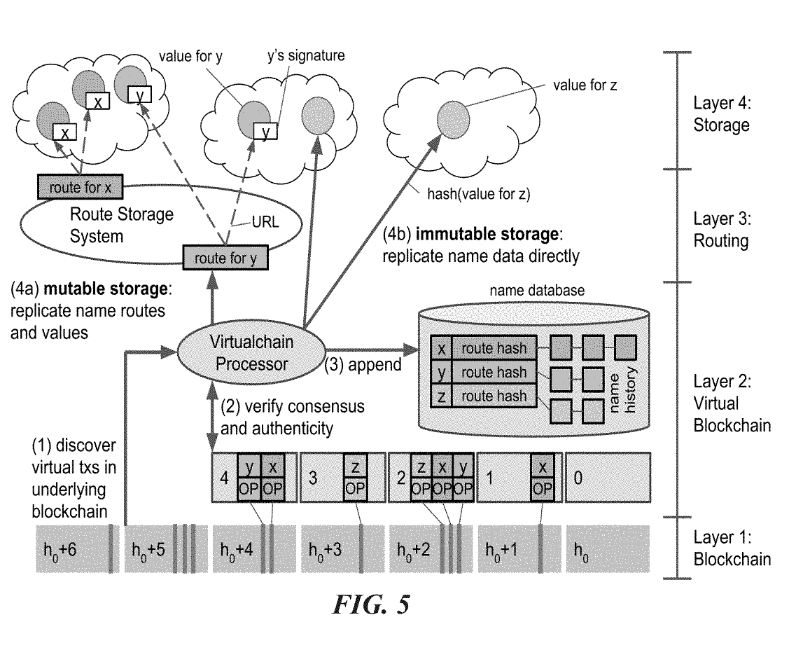

In some embodiments, a system decouples security of name registration and name ownership from data availability of values associated with names. Referring to FIG. 1, FIG. 2, and FIG. 5 a system is designed by separating the control and data planes. The control plane is responsible for registering human-readable names and creating (name;hash) bindings. It also defines the protocol for establishing ownership of names, which are owned by cryptographic keypairs.

The data plane is responsible for data storage and availability. It consists of (a) routing information for discovering data, and (b) external storage systems for storing data. Data values can be signed by private keys of respective owners. Authenticity of data values, retrieved from the data plane, is verified by the control plane by checking either the hash of the data or the signature with the public key.

In some embodiments, instead of relying on any single storage unit, the technologies disclosed herein allow for a variety of storage backends for storing data and separates a routing layer (how to discover data) from actual storage of data. In certain designs, a virtual blockchain binds names with respective hash(route) and stores these bindings in a control plane, whereas the actual routes are stored in a routing layer. In additional embodiments, a control plane does not need to trust the routing layer, because the integrity of routes is verified by checking the hash(route) in the virtual blockchain. In some implementations, Blockstack nodes form a distributed hash table (DHT)-based peer network for storing routing information. Referring FIG. 1, in some embodiments, a DHT only stores routes if hash(route) was previously announced in the blockchain and effectively white-lists the data that can be stored in the DHT. In some embodiments, routes (no matter from where they are fetched) are verified and therefore cannot be tampered with. In other implementations, Blockstack nodes form a peer-network where every peer stores a full copy of all routing information.

In some embodiments, a storage layer is logically constructed on top of a routing layer. A storage layer hosts actual data values of name/value pairs. In some implementations, stored data values are signed by a private-key of the respective owner of a name. By storing data values outside of underlying blockchains, the technologies disclosed herein, in some embodiments, allow values of arbitrary size, and allow for a variety of storage backends. In particular embodiments, a control plane does not need to trust the storage layer, because it can verify the integrity of the data value in the control plane.

In some embodiments, a storage layer comprises two modes which differ in how the integrity of data values is verified. (1) Mutable Storage. Mutable storage is a default mode of operation for a storage layer. In some embodiments, bindings between name and hash(route) are kept in the control plane and the routing layer is used to discover data values. Integrity of data values is verified by checking the signatures of signed values. It allows for faster writes since data updates do not involve any transactions on an underlying blockchain, which has slow writes. Updates to name/value pairs also don't take any bandwidth on an underlying blockchain, where only name registrations take bandwidth. (2) Immutable Storage. In some embodiments, immutable storage by-passes a routing layer and stores bindings between name and hash(value) in a control plane, instead of bindings between name and hash(route). Integrity of data value is checked by hashing the data and checking against the hash(data) from the control plane. This mode is suitable for data values that don't change often and where it is important to verify that you are viewing the latest version of the data value. For immutable storage, updates to data values require a new transaction on the underlying blockchain, making data updates much slower than mutable storage. In some embodiments, a storage layer is configured to include one of the modes, or both modes.

Separating control plane from data plane is a crucial design. The design not only significantly increases the data storage capacity of the naming system, but also allows each plane to evolve and innovate independently of each other.

### Name Operation

In various embodiments, the networks, systems, media, and methods described herein include a name operation. In some embodiments, a name operation comprises one or more of the following: registrations, data record updates, and name transfers.

In some embodiments, a name is owned by a cryptocurrency address of the underlying blockchain and an associated private key e.g., ECDSA-based private keys used in Bitcoin.

In some embodiments, a user preorders and then registers a name in two steps, in order to claim a name without revealing it to the world first (otherwise an attacker can race the user in claiming the name). The first user to successfully write both a preorder and a register transaction owns the name. Any previous preorders become invalid when a name is registered. Once registered, a user can update the name/value pair by sending an update transaction (which changes the name/value binding) and uploading the new value to the storage layer. In additional embodiments, name transfer simply changes the cryptocurrency address that is allowed to sign subsequent transactions; name revoke disables any operations on the name until it expires.

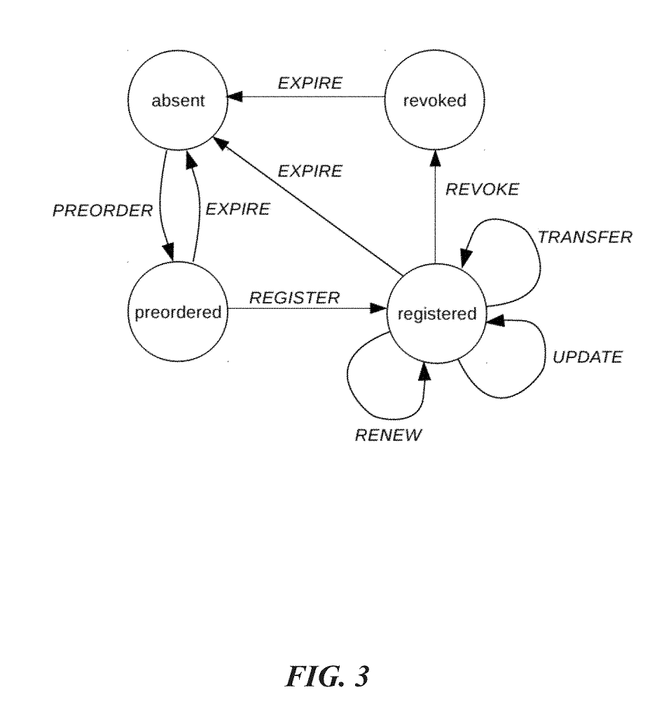

In some embodiments, a naming system is implemented by defining a state machine and rules for state transitions in the virtualchain layer. FIG. 3 shows the different states a name can be in and how state transitions work. Names are organized into namespaces. A namespace is the functional equivalent of a top-level domain (TLD) in DNS—it defines the pricing rules for names, and the name's renewal rate. Like names, a namespace must be preordered and then registered.

Anyone can create a namespace or register names in a namespace, as there is no central party to stop someone from doing so. Pricing function of how expensive it is to create a namespace or register names in a particular namespace is the only way to prevent a “land grab” and stop people from registering a lot of namespaces/names that they don't intend to actually use. In some embodiments, a system disclosed herein enables people to create namespaces with sophisticated pricing functions. For example, .id namespace is used for registering usernames for people and created the .id namespace with a pricing function where (1) price of a name drops with increase in length of a name and (2) introducing non-alphabet characters in names also drops the price. With this pricing function, price of john.id>johnadam.id>john0001.id, and the function is generally inspired by the observation that short names with all-alphabets are considered more desirable on namespaces like Twitter. It's possible to create namespaces where name registrations are free as well.

In some embodiments, the technologies offer variable prices for name registration. Not all names are created equal; meaningful human-readable names are the most squatted. The system disclosed herein addresses this by registering each name in a particular namespace, where each namespace defines the price of a name as a function of its length and the presence/absence of vowels and non-alpha characters.

In some embodiments, the parameters of the pricing function are defined by the namespace creator, but the price is paid by sending cryptocurrency units to an unspendable address (burning them). Once defined, a namespace exists forever, and anyone who can pay can register a name in it. This removes the need for a central name registration system.

In some embodiments, anyone is allowed to create a namespace, but doing so is expensive—shorter namespace identifiers are exponentially more costly than longer ones. For example, the cheapest namespaces in the system (the ones at least 8 characters long in practice) cost 0.4 BTC, which is currently about $350 USD. The technologies described herein can address about 1.07e30 namespaces (all base 38 strings up to 19 characters long), so exhaustion is not a concern.

In various embodiments, creating a namespace is a four-part operation. Like with names, a namespace must be preordered and then revealed, to publish its human-readable identifier and cost function. Then, the namespace creator has the chance to pre-populate the namespace with names via an “import” operation, which atomically registers, sets a value hash and transfers a name to a new owner. Only the namespace creator can issue name operations during this step. Once all names have been imported, the namespace creator declares the namespace ready for new registrations, opening it up to everyone. Namespaces must be made ready within a year of being preordered, thereby disincentivizing . name-squatting within a namespace.

### Name Storage

In various embodiments, the networks, systems, media, and methods described herein include a name-centric storage—every piece of data is keyed to exactly one name. The name storage of the systems and networks has three tiers: the blockchain, data records (e.g., a DHT) maintained by Blockstack peers, and arbitrary third party storage providers (e.g., cloud storage).

In some embodiments, storing data directly into the blockchain (the first tier) is expensive and low-bandwidth. As such, the system disclosed herein uses it only to store state transitions on a name and the hash of the name record's data. In some cases, the system keeps name records themselves in an embedded spam- and sybil-resistant DHT implementation (the second tier). In other cases, the DHT itself is mirrored to enhance its availability, shown in FIG. 1. In yet other cases, a DHT is not used and Blockstack nodes form a peer network where every node replicates a full copy of routing information, which enhances availability. Each name record contains the information assembled from the state transitions, as well as index of data its owner attaches to it. Entries in this index are pointers to data in external commodity storage providers (the third tier).

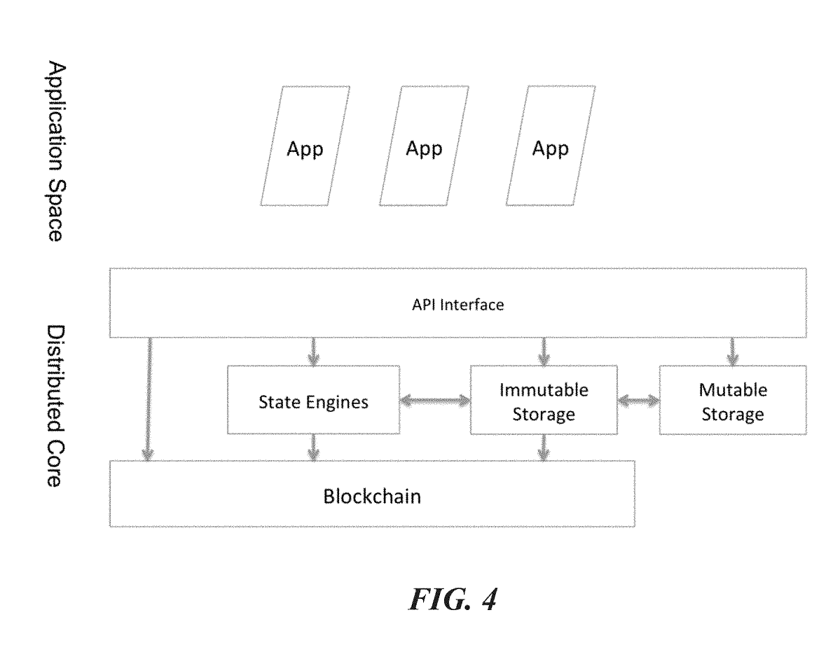

Critically, this three-tiered system allows a system disclosed herein to host an arbitrarily large amount of data for users, and allows users to trade write performance for stronger freshness guarantees by differentiating between mutable data and immutable data. Referring FIG. 4, applications relying on the system disclosed herein remain decoupled from the implementations of particular storage components.

### Consensus Processing

In various embodiments, the networks, systems, media, and methods described herein include a consensus processing, or use of the same. In some embodiments, a peer on a network broadcasts name operations by writing them as transactions on an underlying blockchain. Peer nodes discover them by reading the blockchain and replaying the operations sequentially. In doing so, the blockchain serves as an append-only log of name operations, which when replayed in sequence allows a peer to determine the history of operations on each name and namespace.

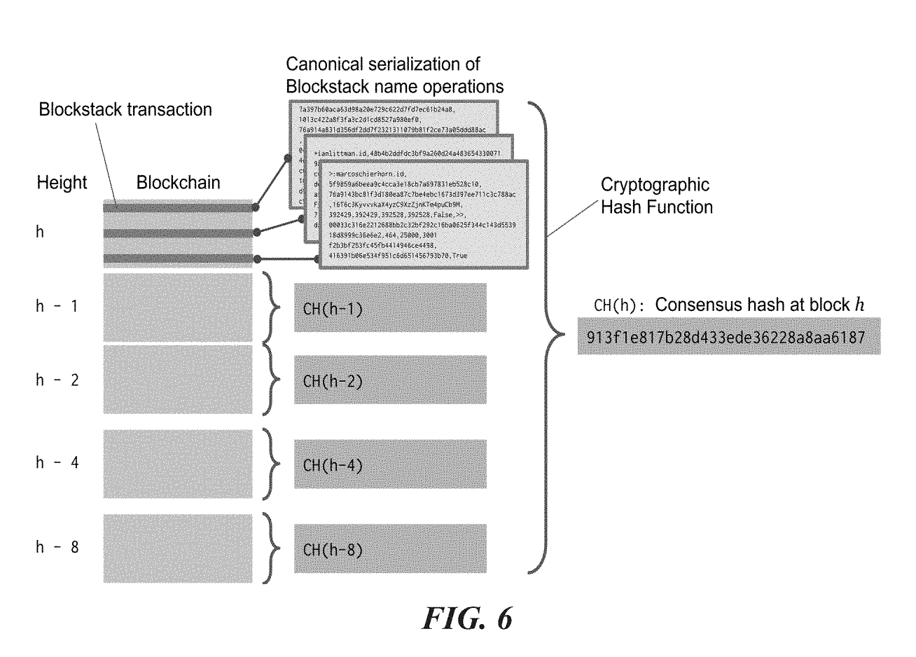

In various embodiments, a consensus processing comprises using a bootstrapping algorithm. In certain embodiments, computing nodes on a network disclosed herein independently calculate a consensus hash at any blockchain block. Referring FIG. 6, a system disclosed herein generates a consensus hash in a deterministic way by hashing a block's sequence of name operations, as well as a logarithmic number of prior consensus hashes. Consensus hashes help computing nodes figure out if they have the same view of the global state at any given block. Each consensus hash CH(h) is constructed from block h's sequence of virtualchain operations Vₕ, as well a geometric series of prior consensus hashes Pₕ defined by: CH(h)=hash(Vₕ+Pₕ), where

Pₕ={CH(h−2ⁱ)|i∈ [symbol] ,h−2ⁱ>=h₀}

and h₀ is the first block. Other than detecting that two computing nodes have the same global view, consensus hashes can also be used to address the endless ledger problem. As the underlying blockchain grows in size, new computing nodes need to process more and more blocks before they catch up to the current state/block.

In some embodiments, a new computing node bootstraps by using an untrusted database of state information at a given block number, and a trusted consensus hash, CH(h), of the same block number. Block number is also known as block height and it increases with each new block. A new node reconstructs the virtual blockchain from the untrusted database and replays operations, recalculating CH(h) at each block height. If the final consensus hash matches the trusted consensus hash at hₙ, then the database associated with hn is trustworthy and the node can start processing blocks after hₙ.

Bootstrapping using an untrusted database along with a trusted consensus hash reduces the bootstrap time of new computing nodes compared to normal bootstrapping. This is because the latter is an exhaustive search—every transaction must be fetched from the blockchain from height h₀, even though most will be discarded because they do not contain virtualchain operations.

On current commodity hardware, booting new computing nodes can take 1-2 hours with a simplified name verification (SNV) vs. 2-4 days without SNV. Moreover, the SNV verification process is CPU-bound—and further optimizations to the implementation can be made.

Queries from Thin Clients

In various embodiments, the systems, networks, software media, and methods support “thin clients”, who can query the past state of the system without running Blockstack nodes or having access to the full blockchain history. Support for thin clients is important for users on mobile devices. The process of verifying the authenticity of a prior name operation with a later trusted consensus hash is called Simplified Name Verification (SNV).

As such, if a user trusts that CH(h) is authentic, then he/she can query and verify the virtualchain operations Vₕ and previous consensus hash Pₕ for block h. In addition, the user gets them from any untrusted source and independently establishes their authenticity. The construction of CH(h) allows a user to verify the authenticity of any virtualchain operation from a block with height hₚᵣᵢₒᵣ<h, using only a logarithmic number of queries. To do so, the user iteratively queries Vₕ and Pₕ for a given h, verifies that they hash to CH(h), and then select h's predecessor h₀ to be the smallest height greater than hₚᵣᵢₒᵣ for which CH(h₀) was previously queried and verified.

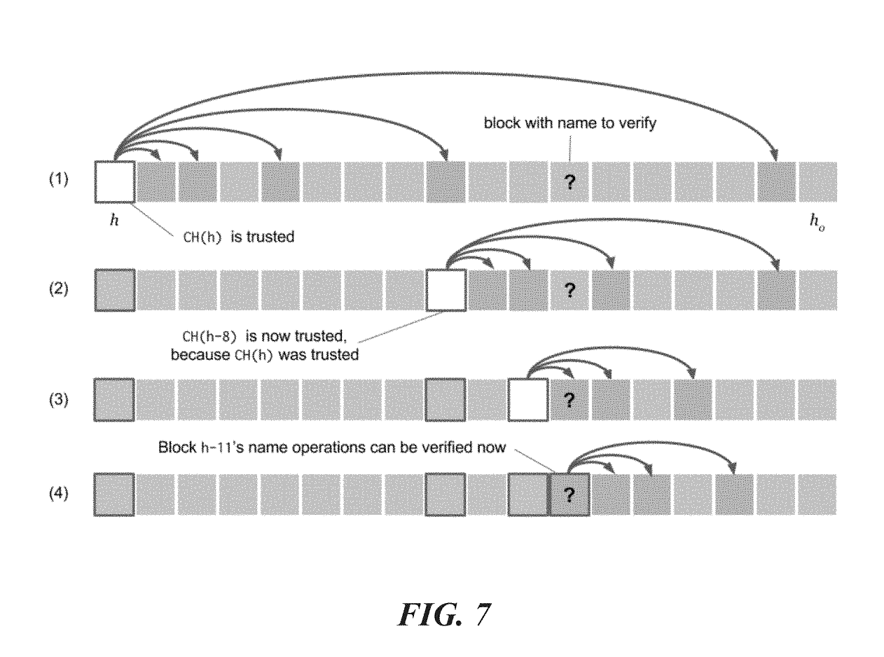

FIG. 7 shows an example SNV query. Each row represents the blockchain, in decreasing block height order from left to right (h₀<h). The user wishes to verify the authenticity of a name operation in a target block (marked with a “?”). In each step, the user trusts the consensus hash for the white outlined block, and uses it to verify the authenticity of that block's name operations, as well as the set of prior consensus hashes (belonging to yellow blocks indicated by the arrows). By iteratively fetching name operations and consensus hashes for prior blocks, the user will eventually prove the authenticity of all name operations in the target block.

### Simplified Name Verification

In various embodiments, the networks, systems, media, and methods described herein include a simplified name verification (SNV), or use of the same. A particular embodiment of SNV is described as follows. Referring FIG. 7, suppose that a user trusts the consensus hash at height h, but needs to verify a name operation in block h-11. Suppose that the blockchain currently has 17 blocks beyond height h₀. To do so, the user queries any computing node to obtain all of the name operations processed at height h, and the consensus hashes for blocks h-1, h-2, h-4, h-8, and h-16. Once obtained, the user serializes the name operations and prior consensus hashes to re-calculate the consensus hash at h. If the trusted consensus hash matches, then the user knows that both the name operations the prior consensus hashes are authentic. The user then iteratively downloads name operations and consensus hashes in this way, until block h-11 is reached. Then, the user will have obtained and verified the authenticity of all name operations in that block, including the desired name operation.

A full trace of the algorithm's execution follows:
Let CH(h) be the consensus hash at block height h.
Let HISTORIC_RECORDS(h) be a subroutine that queries all records affected by transactions in the block at height h. The returned records are in the historic state they were in at height h.

In FIG. 7, step (1):
Fetch HISTORIC_RECORDS(h), CH(h-1), CH(h-2), CH(h-4), CH(h-8), and CH(h-16).
Serialize and hash HISTORIC_RECORDS(h), CH(h-1), CH(h-2), CH(h-4), CH(h-8), and CH(h-16) and verify equal to CH(h). If not, abort.
CH(h-8) is now trusted, and is the closest consensus hash to block h-11.

In FIG. 7, step (2):
Fetch HISTORIC_RECORDS(h-8), CH((h-8)-1), CH((h-8)-2), CH((h-8)-4), and CH((h-8)-8).
Serialize and hash HISTORIC_RECORDS(h-8), CH((h-8)-1), CH((h-8)-2), CH((h-8)-4), and
CH((h-8)-8) and verify equal to CH(h-8). If not, abort.
CH(h-8-2) is now trusted, and is the closest consensus hash to block h-11.

In FIG. 7, step (3):
Fetch HISTORIC_RECORDS(h-8-2), CH((h-8-2)-1), CH((h-8-2)-2), and CH((h-8-2)-4)
Serialize and hash HISTORIC_RECORDS((h-8)-2), CH((h-8-2)-1), CH((h-8-2)-2), and CH((h-8-2)-4) and verify equal to CH(h-8-2). If not, abort.
CH(h-8-2-1) is now trusted, and is the consensus hash of the block with the name operations to verify.

In FIG. 7, step (4):
Fetch HISTORIC_RECORDS(h-8-2-1), CH((h-8-2-1)-1), CH((h-8-2-1)-2), and CH((h-8-2-1)-4).
Serialize and hash HISTORIC_RECORDS(h-8-2-1), CH((h-8-2-1)-1), CH((h-8-2-1)-2), and CH((h-8-2-1)-4) and verify equal to CH(h-8-2-1). If not, abort.
HISTORIC_RECORDS(h-8-2-1) is now trusted. Return the queried record as it was at block h-11.

### Blockchain Fork Detection and Recovery

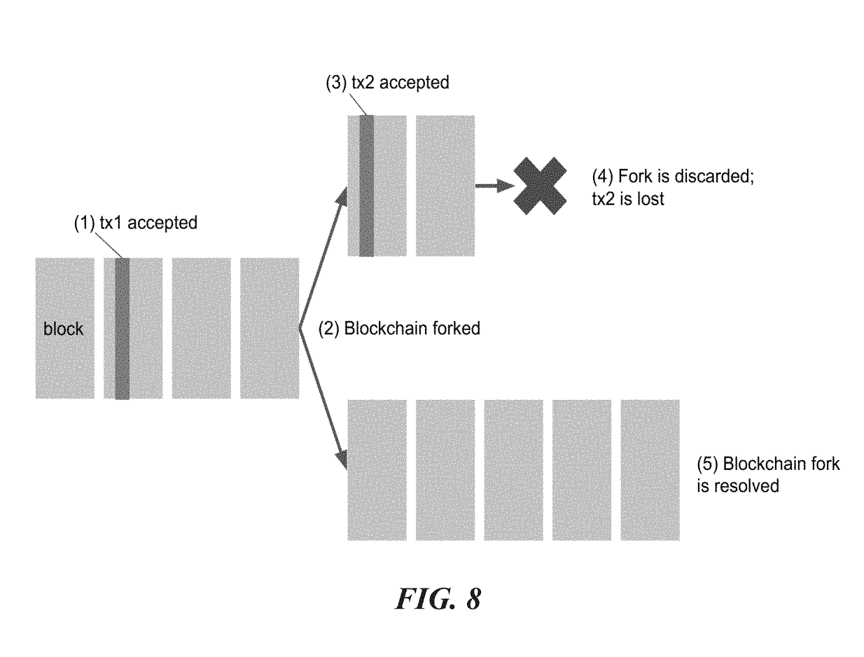

In various embodiments, the networks, systems, media, and methods described herein include a process of blockchain fork detection and recovery, or use of the same. In some embodiments, due to decentralized nature, write stability is not guaranteed. At any given point in time, there can be multiple blockchain forks—different blockchains worked on by disjoint sets of peers that diverge at a particular block. Referring FIG. 8, this can happen if there is a network partition between two or more sets of peers, or if two sets of peers discover a different block for the same height at about the same time.

The way blockchain peers resolve diverging forks is to always attempt to work on the blockchain with the highest proof-of-work (i.e., the fork that cost the most energy to produce), and to discard all other forks. This means that if a blockchain peer submits a transaction, it is possible for the peer to witness the transaction get incorporated into a block, but then later discard the block if the block was later discovered to be on a fork.

The consequence for system disclosed herein is that name operations can get lost if they are incorporated onto a minority fork. This will lead to a divergence in the peers' consensus hashes, since some peers will process name operations on a minority fork while others will not. This is particularly devastating to name registrars that broadcast many name operations in a small amount of time, because they stand to lose a large number of transactions. The challenge is to provide a way to quickly and automatically detect and resolve consensus hash divergences due to blockchain forks, in order to minimize the amount of time required to recover and minimize the number of lost transactions.

Fortunately, if the current block height is h, then the probability that the block at height h-k is on a fork decreases exponentially as a function of k. As a result, a system avoids most forks simply by processing blocks only if they are at least k blocks lower than the highest block in the blockchain. However, this does not eliminate the threat of forks.

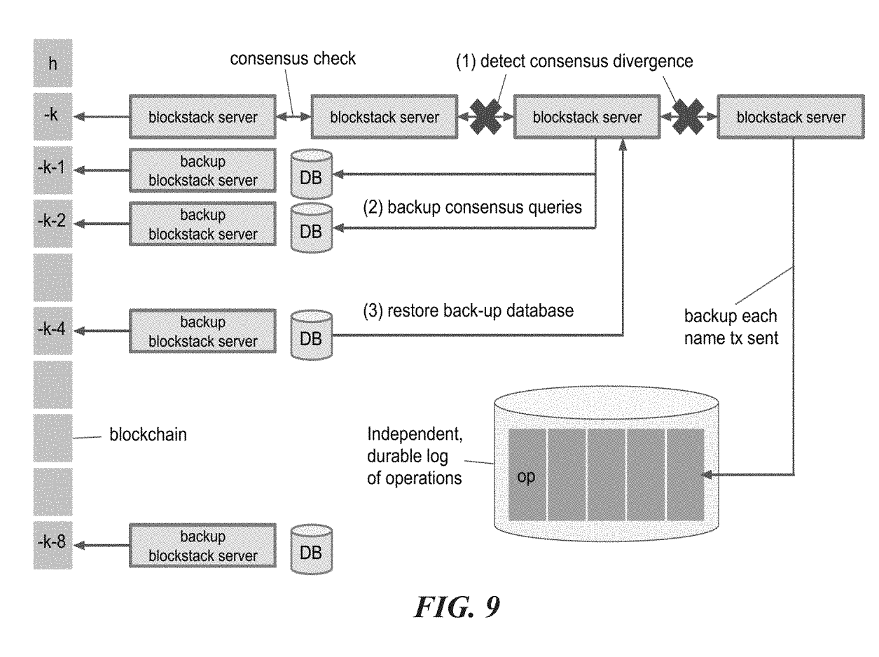

Referring FIG. 9, the solution to detecting forks is to configure a set of mutually-trusting Blockstack peers to fetch the blockchain from different sources, and configure the peers to check every time a new block is discovered to see if they all agree on the same consensus hash at height h-k. If they do not, then a fork at least k blocks long has occurred, and each peer needs to check with the backups to see if it diverged. If it diverged, then it needs to roll back its database to the block height where it diverged, and re-download the blockchain to re-converge on the correct consensus hash.

To facilitate recovery, a peer operator runs an additional set of private, back-up Blockstack peers that process blocks up to heights h-k-2ⁱ, for all positive integers i such that h-k-2ⁱ>=h₀. These peers are not meant to be publicly reachable, but instead curate prior states of all name and namespace records, and serve as recovery checkpoints for the public set of peers processing blocks at height h-k. If a peer processing at height h-k detects that it could be on a fork, it works backwards from the consensus hash at found at height h-k to find a consensus hash at height h-k-2ⁱ where it still agrees with a back-up peer. In particular, it checks each consensus hash down from h-k in a linear fashion, and selects the peer with the largest h-k-2ⁱ that has a consensus hash that agrees. Once found, the peer fetches a copy of the back-up peer's database, authenticates it (if the back-up peer is not trusted), and then re-builds the database up to height h-k by downloading the missing blocks from the blockchain.

The distribution of block heights the back-up peers follow was chosen to balance the number of blocks a peer will need to re-download on recovery against the likelihood of having to recover from a fork of a particular length. The number of blocks a peer must re-download on recovery from a fork at height h-d is minimized when there is a back-up peer with a database at h-d. However, it is inefficient to run h₀-h back-up peers, and most forks are expected to resolve in less than k blocks (those that don't are much more likely to resolve at depth d than at d+1). Selecting a power-of-2 distribution of back-up peer height intervals ensures that a recovering peer will not download more than twice the number of blocks than the minimum number required, while also ensuring that the number of necessary back-up peers grows logarithmically with the blockchain height. In addition, the interval distribution places most back-up peers close to h-k, which we expect to cover nearly all of the fork recovery scenarios for forks greater than k blocks.

In some embodiments, this fork detection and recovery protocol only guarantees that the set of peer nodes are on the same fork; it does not guarantee that they are always on the majority blockchain fork, since it is possible for every peer and corresponding blockchain peer to be on a minority fork. The distribution of peers and the blockchain peers they communicate with must be kept diverse, in order to minimize the chance of this happening. To prepare for this scenario, the peer operator (e.g., a registrar) should replicate each processed name operation, independent of peer nodes, so they can be re-submitted once the fork resolves and the peers are recovered.

### Digital Processing Device

In various embodiments, the subject matter described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-transitory Computer Readable Storage Medium

In various embodiments, the subject matter disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In various embodiments, the subject matter disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions, In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In various embodiments, the subject matter disclosed herein include at least one software module, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In various embodiments, the subject matter disclosed herein include at least one database, or use of the same. In view of the disclosure provided herein, those of skill in the art will recognize that many databases are suitable for storage and retrieval of blockchain, transaction, domain name, routing, and virtual blockchain information. In various embodiments, suitable databases include, by way of non-limiting examples, relational databases, non-relational databases, object oriented databases, object databases, entity-relationship model databases, associative databases, and XML databases. Further non-limiting examples include LevelDB, SQL, SQLite, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

### Example 1

### Name Value Lookup

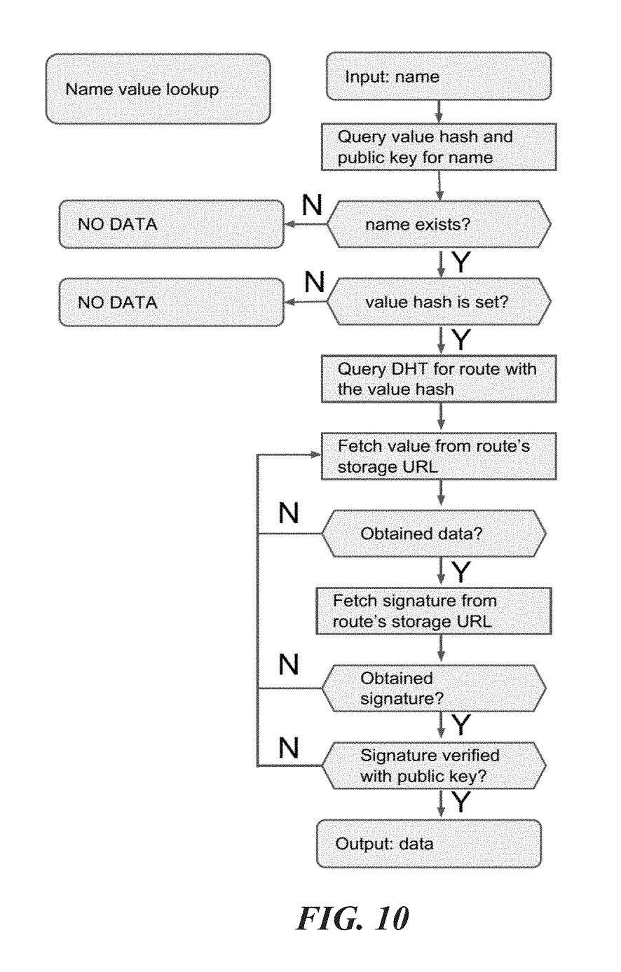

FIG. 10 shows an example of looking up name values. A name is input to the system, which further queries hash value and public keys. If the name exists, the system further processes routing information, obtains data, processes signature.

### Example 2

### Simplified Name Verification

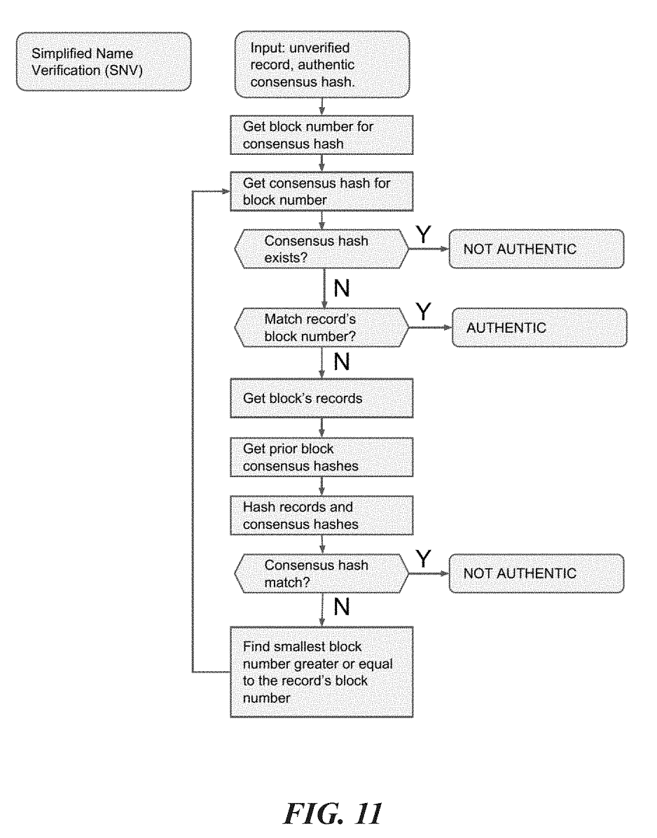

FIG. 11 shows and example of simplified name verification. Input of a system comprises verified records, automatic consensus hash. Then, the system gets block number for consensus hash. If the consensus hash exists, authentication is not made. If not exists, the system looks up matched record's block number. If a match is found, authentication is made. If no match is found, the system gets block's records, prior block consensus hashes, hash records, and consensus hashes.

Finally, the system determines if a consensus hash matches with record data. If match is found, no authentication is made. If no match is found, the system finds the smallest block number greater or equal to the record's block number.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the disclosure. It is intended that the following claims define the scope of the invention and that methods and structures within the scope of these claims and their equivalents be covered thereby.

What is claimed is:

1. A computer-implemented method for processing a global naming system with blockchains on a computer network, the method comprising:
(a) accessing and processing an underlying blockchain, the underlying blockchain comprising existing transactions;
(b) storing data records in one or more data storage units inside or outside of the underlying blockchain, wherein the data records comprise routing information;
(c) issuing a new transaction on the underlying blockchain;
(d) deriving a virtual blockchain by processing the existing transactions in the underlying blockchain and interpreting the existing transactions as a set of virtual blockchain operations;
(e) creating first binding data between a name, a cryptographic keypair, and a bytestring by processing operations in the virtual blockchain, wherein the operations comprise registrations, data record updates, and name transfers; and
(f) updating the first binding data by processing new operations in the virtual blockchain;
whereby a domain name service is provided without a centralized server.

2. The method of claim 1, wherein the name is unique and human-meaningful.

3. The method of claim 1, wherein the bytestring is a record hash, wherein the method further comprises deriving second binding data of the name to the data records based on combining the name to the first binding data with lookups in the one or more data storage units that map the record hash to a hash deriving record, wherein the record hash is derived from the hash deriving record, and wherein the second binding data comprises records comprising routing information.

4. The method of claim 1, wherein the one or more data storage units are further configured to store a distributed hash table.

5. The method of claim 1, wherein the data records are signed by a cryptographic key.

6. The method of claim 1, further comprising associating the virtual blockchain with a second underlying blockchain.

7. The method of claim 1, further comprising executing a two-phase commit process allowing preordering a name before registering it.

8. The method of claim 1, further comprising processing consensus by analyzing a global state of a block in the underlying blockchain.

9. The method of claim 8, wherein the analyzing the global state comprises a use of a bootstrapping algorithm.

10. The method of claim 1, further comprising calculating a price of name registration based on one or more characteristics of the name.

11. A computer network for processing a global naming system with blockchains, the network comprising:
(a) a plurality of computing devices, wherein each said computing device comprises at least one processor, a memory module, and an operating system; and the plurality of the computing devices communicates based on a peer-to-peer protocol; and
(b) one or more data storage units being located inside or outside of an underlying blockchain and configured to store data records comprising routing information;
wherein:
i) one of said computing devices accesses and processes the underlying blockchain, the underlying blockchain comprising existing transactions;
ii) one of said computing devices issues a new transaction on the underlying blockchain;
iii) one of said computing devices derives a virtual blockchain by processing the existing transactions in the underlying blockchain and interpreting the existing transactions as a set of virtual blockchain operations;
iv) one of said computing devices creates first binding data between a name, a cryptographic keypair, and a bytestring by processing operations in the virtual blockchain, wherein the operations comprise registrations, data record updates, and name transfers; and
v) one of said computing devices updates the first binding data by processing new operations in the virtual blockchain;
whereby a domain name service is provided on the network without a centralized server.

12. The network of claim 11, wherein the name is unique and human-meaningful.

13. The network of claim 11, wherein the bytestring is a record hash, wherein one of said computing devices derives second binding data of the name to the data records based on combining the name to the first binding data with lookups in the one or more data storage units that map the record hash to a hash deriving record, wherein the record hash is derived from the hash deriving record, and wherein the second binding data comprises records comprising routing information.

14. The network of claim 11, wherein the one or more data storage units are further configured to store a distributed hash table.

15. The network of claim 11, wherein the data records are signed by a cryptographic key.

16. The network of claim 11, wherein one of said computing devices associates the virtual blockchain with a second underlying blockchain.

17. The network of claim 11, wherein one of said computing devices executes a two-phase commit process allowing preordering a name before registering it.

18. The network of claim 11, wherein one of said computing devices processes consensus by analyzing a global state of a block in the underlying blockchain.

19. The network of claim 18, wherein the analyzing the global state comprises a use of a bootstrapping algorithm.

20. The network of claim 11, wherein one of said computing devices calculates a price of name registration based on one or more characteristics of the name.

21. Non-transitory computer readable media storing machine readable instructions executable by a processor to create an application for processing a global naming system with blockchains, the application comprising:
(a) a software module configured to store data records in one or more data storage unites, wherein the one or more data storage units are inside or outside of an underlying blockchain and the data records comprises routing information
(b) a software module configured to access and process the underlying blockchain, the underlying blockchain comprising existing transactions;
(c) a software module configured to issue a new transaction on the underlying blockchain;
(d) a software module configured to derive a virtual blockchain by processing the existing transactions in the underlying blockchain and interpreting the existing transactions as a set of virtual blockchain operations;
(e) a software module configured to create first binding data between a name, a cryptographic keypair, and a bytestring by processing operations in the virtual blockchain, wherein the operations comprise registrations, data record updates, and name transfers; and
(f) a software module configured to update the first binding data by processing new operations in the virtual blockchain;
whereby a domain name service is provided without a centralized server.

22. The media of claim 21, wherein the name is unique and human-meaningful.

23. The media of claim 21, wherein the bytestring comprises a record hash, wherein the application further comprises a software module configured to derive second binding data of the name to the data records based on combining the name to the first binding data with lookups in the one or more data storage units that map the record hash to a hash deriving record, wherein the record hash is derived from the hash deriving record, and wherein the second binding data comprises records comprising routing information.

24. The media of claim 21, wherein the data records are signed by a cryptographic key.

25. The media of claim 21, wherein the application further comprises a software module configured to associate the virtual blockchain with a second underlying blockchain.

26. The media of claim 21, wherein the application further comprises a software module configured to execute a two-phase commit process allowing preordering a name before registering it.

27. The media of claim 21, wherein the application further comprises a software module configured to process consensus by analyzing a global state of a block in the underlying blockchain.

28. The media of claim 27, wherein the analyzing the global state comprises a use of a bootstrapping algorithm.

29. The media of claim 21, wherein the application further comprises a software module configured to calculate a price of name registration based on one or more characteristics of the name.

30. A computer-implemented method of using an authentic record in a blockchain to determine authenticity of an older record in the blockchain on a computer network, the method comprising:
(a) generating a new record comprising a block number and a cryptographic hash, wherein the block number is a number of blocks in a blockchain at a time when the new record is created;
(b) appending the new record to an end of the blockchain, wherein the new record and existing records in the blockchain are stored as a sequence of transactions in the blockchain and are grouped into blocks;
(c) deriving a second cryptographic hash for a first block from a first cryptographic hash of records in the first block and previously-calculated cryptographic hashes of a geometric sequence of prior blocks;
(d) selecting records from the first block to derive the second cryptographic hash in step (c), wherein the records are associated with block numbers within a fixed range of the first block's blockchain-determined number;
(e) deriving the geometric sequence of prior blocks as blocks separated by exponentially increasing intervals, starting from block number and decreasing;
(f) deriving a skip-list of blocks, such that directed edges originating from a block point to the prior blocks used to derive the second cryptographic hash;
(g) querying the first block's records by using the second cryptographic hash of the first block with a greater block number and traversing the skip list;
(h) traversing the skip list by re-calculating the second cryptographic hash for each visited block and verifying that the re-calculated cryptographic hash matches a cryptographic hash of an already-visited block; and
(i) authenticating an earlier record by using an authenticated record with a larger block number by querying the earlier record's block;
whereby a name ownership verification service is provided that removes the need for the verifying computer to trust a central authority or first obtain a full copy of the blockchain.
